(19) United States
(12) Patent Application Publication
(10) Pub. No.: US 2006/0184616 A1
(43) Pub. Date: Aug. 17, 2006

(54) Method and system of managing conflicts between applications using semantics of abstract services for group context management

(75) Inventors: Kyung-ho Park, Suwon-si (KR); Woo-shik Kang, Suwon-si (KR); Insuk Park, Daejeon (KR); Dongman Lee, Daejeon (KR); Soon Joo Hyun, Daejeon (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electro-Mechanics Co., Ltd.

(21) Appl. No.: 11/350,836

(22) Filed: Feb. 10, 2006

(30) Foreign Application Priority Data
Feb. 14, 2005 (KR) 10-2005-0011945

(51) Int. Cl. G06F 15/16

(52) U.S. Cl. 709/203

(57) ABSTRACT

A method and a system of managing conflicts between context-aware applications by use of semantics of abstract service for group context information management. The method includes detecting and resolving a conflict between context-aware applications; upon receiving a service request from an application, analyzing a semantic of the requested service; and registering the semantic into a data structure. A determination is made whether a conflict between service actions occurs in the data structure and when the conflict occurs, removing the semantics of the conflicting service actions from the data structure. The conflict between the service actions arises when actions of the valid applications according to the user policies contradict the same context information in the data structure. After removing the semantics of the service actions from the data structure, a resolution policy for the conflict is generated, and a new service is requested according to the resolution policy.

### CROSS-REFERENCE TO RELATED APPLICATIONS

This application claims priority from Korean Patent Application No. 10-2005-0011945 filed on Feb. 14, 2005 in the Korean Intellectual Property Office, the entire disclosure of which is incorporated herein by reference.

### BACKGROUND OF THE INVENTION

1. Field of The Invention

Methods and systems consistent with the present invention broadly relate to conflict management between applications, and more particularly, to detecting and resolving conflicts between context-aware applications by use of semantics of abstract services for group context information management.

2. Description of The Related Art

Context-awareness technique is one of crucial technologies of ubiquitous computing, and provides intended and desired services to users by collecting information relating to locations, environments, and states of the users. Context-aware applications refer to applications which provide intended services to users without explicit requests from the users by use of the context-aware technique.

Research on the context-aware applications has been successful in efficiently satisfying at least some of user's requirements by accurately capturing context information of the user, processing and managing the context information so that applications can utilize it. However, a context-aware application, which does not account for other users in an environment where members are living together in a place like home, may cause a situation where services of the application of a certain user invade interests of the other users. Such a situation arises because the context information is differently interpreted in view of the respective users even in the same environment.

Conventional context-aware applications have been developed by considering context information of other nearby users at the development phase so as to avoid undesirable situations. However, such an approach drastically increases the complexity in developing the context-aware applications. Additionally, it is practically impossible to expect and resolve potential conflicts due to characteristics of the ubiquitous computing having high user mobility and frequent environmental changes. Hence, to realize conflict-free execution of the conventional personalized context-aware applications in the ubiquitous environment, a function is demanded in which conflicts will be dynamically detected and resolved at the middleware rather than at the applications.

Conventional methods for the detection and resolution of conflicts between the context-aware applications include a Gaia system and a CARISMA system. The Gaia system defines actions of the context-dependent application in a form of rules and gives priority to the rules. When more than two rules are activated simultaneously in the same situation, the Gaia system resolves the conflict between the context-aware applications by executing the application with a higher priority. However, the Gaia system cannot satisfy all users at all times because the priority of the rules should be predefined at the development phase of the context-aware applications and only one activated rule can be executed according to the priority of the rules.

As for the CARISMA system, it is assumed that conflicts arise when a plurality of user policies which satisfy a given situation in one context-aware application is activated at the same time (intra-profile), and when a service is shared by context-aware applications of a plurality of users for collaborations such as chatting or video conference but the service is used by different policies (inter-profile). In addition, an algorithm is developed to dynamically adapt the applications so as to satisfy the requirements of all users at a maximum based on quality items and user preference on the quality items, without predefining conflict resolutions for the detected conflicts. However, disadvantageously, the CARISMA system cannot detect conflicts between the context-aware applications which are independently developed because of other users.

As such, the conventional conflict detection and resolution for the context-aware applications assume the conflicts in an application only when a plurality of user policies simultaneously responds to a given context information, and when a plurality of applications interacts with each other using the same service and uses disparate policies for a given context information. However, the conflicts may arise not only when the user policies of the application respond to a given situation at the same time but also when the context information changed by a previous user policy is modified or destroyed by the user policy of another user. The conventional methods cannot detect such conflicts.

Furthermore, the conventional methods resolve the conflicts by selecting any one of user policies causing the conflicts based on the priority or the user preference of the user policies, which is prescribed at the development of the application for the detected conflicts. Accordingly, the conventional methods cannot satisfy all the users. Also, it is impossible to detect and resolve unexpected conflicts because only the prescribed conflicts can be detected and resolved. However, since it is almost impossible to predefine all possible conflicts due to the presence of plural users with high user mobility in the ubiquitous environment, the conventional methods cannot be practical solutions.

### SUMMARY OF THE INVENTION

The present invention has been provided to address the above-mentioned and other problems and disadvantages occurring in the conventional arrangement. Illustrative, non-limiting embodiments of the present invention may overcome the above disadvantages and other disadvantages not described above. The present invention is not necessarily required to overcome any of the disadvantages described above, and the illustrative, non-limiting embodiments of the present invention may not overcome any of the problems described above. The appended claims should be consulted to ascertain the true scope of the invention.

The present invention provides a method and a system for managing conflicts between applications by managing effects on context information by an action of an application, a type of affect on the context information, and a valid time period of the action, determining whether an action of an application for one user damages other users, and dynamically detecting and resolving the conflicts.

According to an aspect of the present invention, there is provided a method for managing and resolving conflicts between context-aware applications. The method includes receiving a service request from an application; analyzing and registering a semantic of the requested service to a data structure; determining whether a conflict occurs between service actions which are registered to the data structure; when a conflict occurs, removing semantics of conflicting service actions from the data structure and generating a resolution policy for the conflict; and requesting a new service according to the resolution policy.

The method may further include executing the requested service when a conflict does not occur.

The data structure may be an ontology which represents a type of effects actions of the application have on the context information, and affected context information.

The method may further include detecting changes in the context information and removing from the data structure a semantic of a service action which does not satisfy a given context information.

A conflict occurrence may be determined by detecting when valid actions of the application according to a user policy have contradictory semantics in the data structure with respect to the same context information.

The method may further include determining conflicts between actions which are not predefined in advance in the data structure, based on the type of effect they have on the context information without regard to names or types of actions of the application.

According to an aspect of the present invention, there is provided a system for detecting and resolving conflicts between context-aware applications, includes a context consumer which receives a service request from an application; an action semantic manager which analyzes a semantic of the requested service, registers, and removes the semantic to and from a data structure; and a service interaction broker which determines whether a conflict occurs between service actions which are registered to the data structure, and when a conflict occurs, requests the action semantic manager to remove semantics of conflicting service actions from the data structure, generates a resolution policy for the conflict, and requests a new service according to the resolution policy. The data structure may be an ontology which represents a type of effects the actions of the application have on the context information, and affected context information.

### BRIEF DESCRIPTION OF THE DRAWINGS

The above and/or other aspects of the present invention will become apparent and more readily appreciated from the following description of exemplary embodiments, taken in conjunction with the accompanying drawings in which:

FIG. 1 is a diagram illustrating middleware modules for controlling conflicts between context-aware applications according to an exemplary, non-limiting embodiment of the present invention;

FIG. 2 is a block diagram of a system for managing conflicts between applications according to an exemplary, non-limiting embodiment of the present invention;

FIG. 3 is a diagram illustrating an action semantic ontology for abstracting and representing actions of an application with effects on context information according to an exemplary, non-limiting embodiment of the present invention;

FIG. 4 illustrates a program using an action semantic management function according to an exemplary, non-limiting embodiment of the present invention;

FIG. 5 is a flowchart outlining a method of managing conflicts between applications according to an exemplary, non-limiting embodiment of the present invention;

FIG. 6 is a diagram illustrating semantic definitions of a service actions in a light service according to an exemplary, non-limiting embodiment of the present invention; and

FIG. 7 is a diagram illustrating semantic definitions of service actions in a picture-in-picture (PIP) display according to an exemplary, non-limiting embodiment of the present invention.

### DETAILED DESCRIPTION OF THE EXEMPLARY EMBODIMENTS

Certain exemplary embodiments of the present invention will now be described in greater detail with reference to the accompanying drawings.

In the following description, same drawing references denote analogous elements even in different drawings. The matters defined in the description, such as detailed construction and element descriptions, are provided to assist in a comprehensive understanding of the present invention. Also, well-known functions or constructions are not described in detail since they would obscure the present invention in unnecessary details.

In an exemplary, non-limiting embodiment of the present invention, management of conflicts in group context information between context-aware applications is provided. The context-aware applications are developed to support individuals taking into account other users when a plurality of users coexists in a space, and dynamically detecting the conflicts predefined in the applications.

An exemplary embodiment of the present invention presumes that in a ubiquitous environment for a plurality of users, independent context-aware applications are developed for the respective users without considering other users and are executed together in the same place. When a plurality of users exists in the same place, an action of an application may affect other users. Specifically, as the application is independent from the other users except for designated specific user, the action of the application may cause damage to the other users by accidentally inducing unintended action to the other users. In these circumstances, it is impossible to predict when, where, and how a certain user impacts other users, at the application development phase. Therefore, a conflict detection and resolution model is needed that would dynamically detect and resolve conflicts without having to predefine conflicts during the development of the applications.

It is necessary to guarantee transparency for conflicts between applications to a developer and lower complexity of the application development by separating the conflict detection and resolution model from the application development environment and entrusting the model to a middleware so that the developer can develop the application without the need to account for other users' applications. Additionally, it is needed to detect conflicts not only in one application supporting multiple users or applications of a plurality of users who collaborate, but also between applications of a plurality of users who carry out their respective independent operations. Only when such requirements are satisfied, legacy context-aware applications can normally operate in the ubiquitous environment.

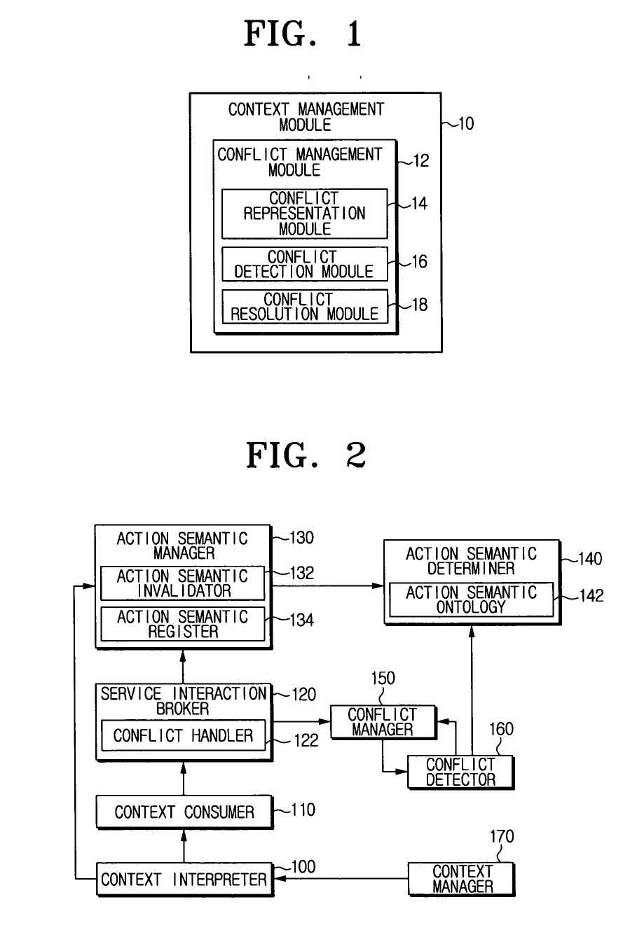

FIG. 1 depicts middleware modules for managing conflicts between context-aware applications. A middleware installed to, for example, a home server, includes a context management module 10. The context management module 10, as shown in FIG. 1, includes a conflict management module 12. The conflict management module 12 includes a conflict representation module 14, a conflict detection module 16, and a conflict resolution module 18.

The conflict representation module 14 defines an ontology for abstracting and representing services used as actions of an application according to their effect on context information. The conflict detection module 16 represents the actions of the application executed according to a user policy as an abstract semantic in the ontology and manages a valid period of the actions. For every request of an action defined by the user policy from the application, the conflict detection module 16 modifies the semantic of the requested action in the ontology. When two disparate actions are valid but have mutually contradictory effects with respect to certain context information, the conflict detection module 16 detects this situation as a conflict. The conflict resolution module 18 establishes a resolution policy for the detected conflict.

A method of managing conflicts between applications according to an exemplary embodiment of the present invention aims for the conflict detection not only when context-dependent user policies which are activated simultaneously in a given situation conflict with each other but also aims at detecting the conflict when a user policy activated by changes of the situation modifies or destroys a user policy of another user whose policy was previously activated and is still valid even when the situation changes. To this end, a demand arises for a module for dynamically managing user policies, which are activated in a given situation and affect context information, and services executed by the user policies.

In addition, to dynamically detecting conflicts without having to describe the conflicts between services one by one, a data structure is required to abstract and represent semantics of service actions by their effects on the context information or state information of the services, and to manage and store the information during the execution.

When the developer describes the request of the intended service of the user in the given situation, a dynamic invocation interface (DII) of Java application program interface of extensible markup language based on a remote procedure call (JAX-RPC) is utilized. The middleware takes charge of the semantic management of service actions for the context detection. Thus, the development environment transparent to the context conflict can be provided to the developer. To provide the development environment transparent to the context conflict, it is required that the middleware analyze the semantics of the service actions according to names and arguments of the service actions at the execution of the service actions, modify the action semantic ontology, to be explained in greater detail below, and invalidate a semantic of a service action which does not satisfy the given context information any more in the action semantic ontology by detecting changes in the context information.

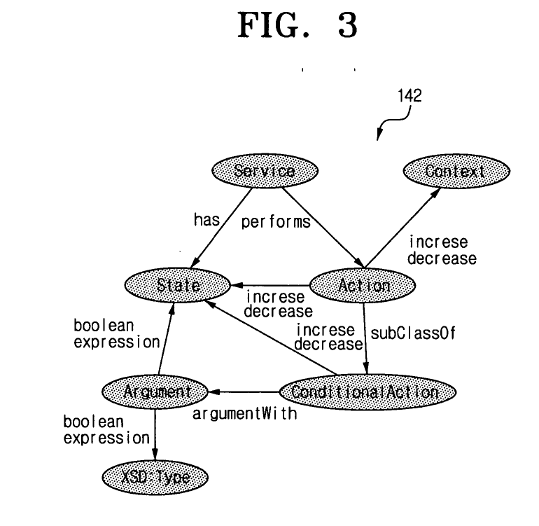

FIG. 2 is a block diagram of a system for the conflict management between applications according to an exemplary embodiment of the present invention. Referring to FIG. 2, the conflict management system includes a context interpreter 100, a context consumer 110, a service interaction broker 120, an action semantic manager 130, an action semantic determiner 140, a conflict manager 150, a conflict detector 160, and a context manager 170. The service interaction broker 120 includes a conflict handler 122. The action semantic manager 130 includes an action semantic invalidator 132 and an action semantic register 134. The action semantic determiner 140 includes an action semantic ontology 142.

When there are changes in the context information of the application, the context interpreter 100 examines whether a given situation matches a user's intended situation. When two situations match, the context interpreter 100 notifies the context consumer 110 of the situation match by sending an event. The context consumer 110 is a template of the application program and has message objects for representing services. The context consumer 110, upon receiving the event from the context interpreter 100 when the given situation matches the user's intended situation, requests services to the middleware via an application program interface (API), or requests the invalidation of the previously requested services.

The conflict handler 122 in the service interaction broker 120 intercepts the service request from the application being delivered from the context consumer 110 so that the service interaction broker 120 may examine whether a conflict is present prior to the service execution. The service request from the application is forwarded to the conflict handler 122 which acts as a communication channel, in a form of a simple object access protocol (SOAP) message, for example. The conflict handler 122 analyzes the semantics of the services by utilizing the action semantic manager 130 and requests the update of the action semantic ontology 142.

The action semantic register 134 in the action semantic manager 130 analyzes the semantics of the services when the service request is received from the application, and registers them in the action semantic ontology 142. The action semantic invalidator 132 detects changes of the context information and removes from the action semantic ontology 142, the semantics of service actions which are unsatisfactory to the given context information. When a semantic of service is added to the action semantic ontology 142 by the action semantic manager 130, the conflict handler 122 requests the conflict manager 150 to infer whether the requested service causes a conflict. The conflict manager 150 queries the conflict detector 160 to determine whether the requested service causes a conflict. The conflict detector 160 searches contradictory service actions with respect to the same context information or service state information in the service semantics registered in the action semantic ontology 142 by the action semantic determiner 140. When a conflict is detected according to a result of the search, the conflict detector 160 notifies the conflict manager 150 of an existing conflict. The conflict manager 150 requests the action semantic manager 130 to remove the conflicting service semantics from the action semantic ontology 142, generates a new service request message, and controls the conflict detection procedure, which is recursively performed, using the generated message. By contrast, when the conflict is not detected, the service request message is forwarded to the service interaction broker 120 to execute the service.

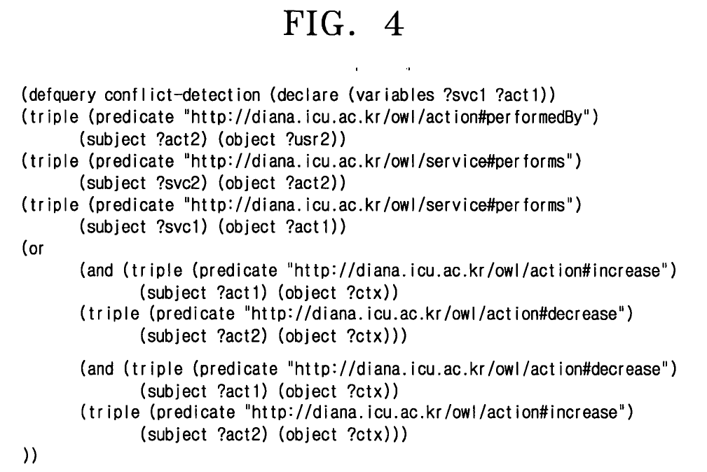

FIG. 3 depicts an example of the action semantic ontology 142 according to an exemplary embodiment of the present invention. The ontology is a definition or a specification of vocabularies or concepts, and represents components (concepts) corresponding to the contents of the system. In the exemplary embodiment of the present invention, the ontology abstracts and represents the services, which are defined by actions of the application, by indicating the effect of actions on the context information. Particularly, the exemplary embodiment of the present invention defines the ontology to represent effects of the service actions, and abstracts the service actions by their respective effect on the context information and the service state information, as shown in FIG. 4.

Additionally, the actions of the application executed according to the user policy are represented as abstract semantics in the ontology using an action semantic management function, as shown in FIG. 4, and the valid period of the actions is managed. Thus, for every requested action defined by the user policy for the application, the semantic of the requested action is modified in the ontology 142. When two contradictory actions are valid with respect to certain context information, the conflict is detected.

As shown in FIGS. 3 and 4, when the application requests the execution of service methods in response to the given context information by use of abstract information relating to the service methods which are described at the service development of “action semantic management function”, the abstract information is recorded in the ontology. The effect of the service action is represented as increase or decrease of a corresponding value. In the exemplary embodiment of the present invention, the service is defined with an action which changes value of the state information by using the state information. This service definition conforms to a service model of universal plug and play (UPNP). The service action changes the state information managed by the service. At this time, the service semantic may be set to one all the time or set unrelated to characteristics of the argument or the relationship between the argument and the state information. In short, the service semantic is not fixed.

For instance, ‘turnON’ action of ‘LightService’ acts to increase the variable of ‘LoadLevelState’ all the time, whereas ‘addVolume’ of ‘AudioService’ acts to increase the variable of ‘Volume’ when the argument is positive or to decrease the variable when the argument is negative. Accordingly, the service action can be categorized into an ‘Action’ type which has only one semantic constantly, and a ‘ConditionalAction’ type which has variable semantics according to “Argument”.

As for the ‘ConditionalAction’ type, the semantic is differently interpreted for every invocation depending on the characteristics of “Argument”. The relevant rule is defined as a rule expression as shown in FIG. 4 by a service developer or an application developer. The service action changes not only the state information managed by the service but also the value of the context information relating to the environment where the service is executed. For instance, in case that the application requests the action ‘TurnOn’ for ‘LightService’, the action also changes the luminance of the room as well as ‘LoadLevelState’ being the state information of ‘LightService’. Accordingly, ‘Action’ can establish the relationship with ‘State’, similarly to ‘Context’. Such a semantic of the service action allows detection not only of conflicts between two actions, which contradictorily change the state information for the same service, but also conflicts between contradictory actions which affect the state information even in the difference services.

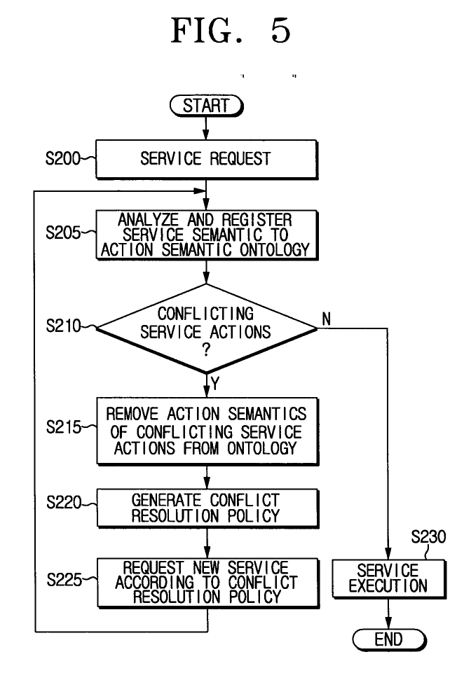

FIG. 5 is a flowchart outlining a method of managing conflicts between applications according to an exemplary embodiment of the present invention. Referring to FIG. 5, when a service request is received from the application (S200), the service semantic is analyzed and registered to the action semantic ontology (S205). Next, a determination is made whether there are contradictory service actions which cause conflict with respect to the same context information or service information in the action semantic ontology (S210). According to a result of the determination at operation S210, when the conflicting service actions are present, the action semantics of the conflicting services are removed from the action semantic ontology (S215). Next, a conflict resolution policy is generated for the conflicting service actions (S220). A new service is requested according to the conflict resolution policy (S225). By contrast, when there are no conflicting service actions according to the determination in operation S210, the requested service is executed (S230). This procedure is repeated until there are no conflicting service actions.

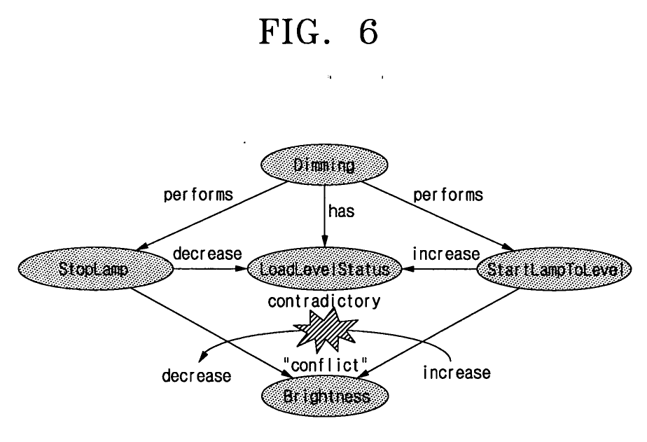

FIG. 6 depicts semantics of Light service actions. As aforementioned, at the development of the service used as the action of the application, types of the context information affected by methods of the service, and the types of the effects on the context information (increase or decrease) are described.

For instance, as shown in FIG. 6, when the method ‘StartLampToLevel’ of the service ‘Dimming’ is executed, ‘Brightness’ of the context information is increased. When the method ‘StopLamp’ is executed, ‘Brightness’ is decreased. Hence, when a user falls asleep, an application for regulating the light by turn-off requests the execution of the method ‘Diming’ or ‘StopLamp’ in response to the state information of the user. The request is delivered to the action semantic management module and generates ‘decrease’ connection between the ‘StopLamp’ node and the ‘Brightness’ node in the ontology. The relation is regarded as valid and managed until the state information of the user changes.

When another user enters the room, an application for regulating the light by turning it on, detects the entrance of another user in response to location information of another user, and requests the execution of the method ‘StartLampToLevel’ to the ‘Dimming’ service. The request generates an ‘increase’ connection from the ‘StartLampToLevel’ node to the ‘Brightness’ node in the ontology, as described earlier. As a result, when another user enters the room where the user is sleeping, the ‘increase’ connection is generated while the ‘decrease’ connection is still valid. When such contradictory semantic connections are valid simultaneously for the same state information, the contradictory semantic patterns for the state information can be discovered through the inference based on the ontology during the execution of the method ‘detect’ and thus the conflict can be detected. That is, the two actions (‘StopLamp’ and ‘StartLampToLevel’) of the service ‘Dimming’ impact the state of the service ‘LoadLevelStatus’ in a contradictory way. Accordingly, a conflict is detected.

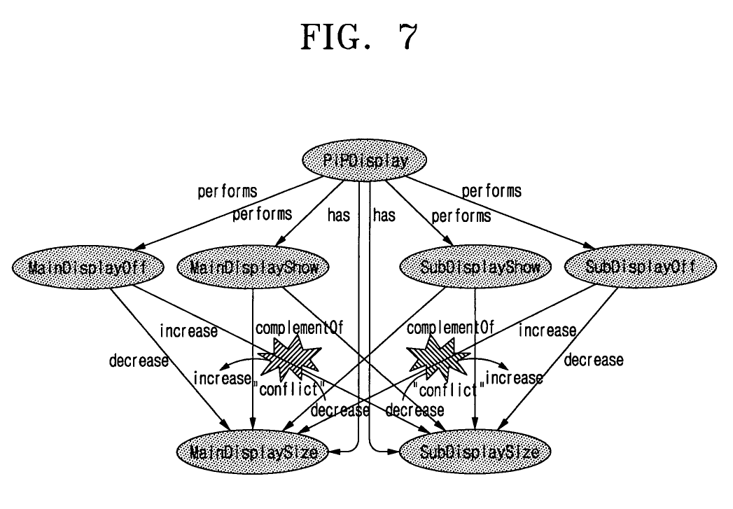

FIG. 7 depicts semantics of service actions at a picture-in-picture (PIP) display according to an exemplary embodiment of the present invention. Referring to FIG. 7, with respect to ‘MainDisplaySize’, ‘increase’ of ‘MainDisplayShow’ conflicts with ‘decrease’ of ‘SubDisplayShow’. In addition, with respect to ‘SubDisplaySize’, ‘decrease’ of ‘MainDisplayShow’ conflicts with ‘increase’ of ‘SubDisplayShow’. There are also provided actions ‘MainDisplayOff’ and ‘SubDisplayOff’. When the ‘SubDisplayOff’ is requested, the ‘MainDisplaySize’ increases and the ‘SubDisplaySize’ decreases. When the ‘MainDisplayOff’ is requested, the ‘MainDisplaySize’ decreases and the ‘SubDisplaySize’ increases.

In the exemplary embodiment of the present invention, in the inference using the ontology, only semantics of the represented connections in the context information are used. Thus, conflicts can be dynamically detected and resolved without having to specifically describe other conflicting services for each service at the service development phase.

As set forth above, exemplary embodiments of the present invention can detect not only the conflict supported by the conventional context-aware application, that is, when a plurality of user policies respond to a give situation at the same time, but also the conflict when the previous user policy is still valid and another user policy attempts to modify or remove the context information which has been altered by the previous user policy although a plurality of user policies do not respond at the same time. Therefore, the conflict detection range of the context-aware applications can be extended. Additionally, without having to specifically describe at the application development phase which user policies conflict in a given situation, the conflicts can be dynamically detected only by using the types of the context information affected by the actions of the application according to the user policy and the types of the effect. Therefore, the application can be developed without considering conflicts with the user policy of other applications at the development phase. As a result, the burden on the application developer can be alleviated and the complexity of the application development can be lowered.

While the exemplary embodiments of the present invention have been particularly described with reference to the accompanying drawings, it will be understood by those skilled in the art that various changes in form and details may be made therein without departing from the spirit and scope of the invention as defined by the appended claims.

What is claimed is:

1. A method of managing and resolving conflicts between context-aware applications, the method comprising:
receiving a service request from an application;
analyzing and registering a semantic of the requested service to a data structure;
determining whether a conflict occurs between service actions which are registered to the data structure; and
if the conflict occurs, removing semantics of conflicting service actions from the data structure, generating a resolution policy for the conflict and requesting a new service according to the resolution policy.

2. The method of claim 1, further comprising executing the requested service if the conflict does not occur.

3. The method of claim 1, wherein the data structure is an ontology which represents a type of effects the service actions of the application has on the context information, and affected context information.

4. The method of claim 1, further comprising detecting changes in the context information and removing a semantic of a service action which does not satisfy a given context information from the data structure.

5. The method of claim 1, wherein the conflict is determined based on whether valid actions of the application according to a user policy have contradictory semantics in the data structure with respect to same context information.

6. The method of claim 1, further comprising determining conflicts between actions which are not predefined in advance in the data structure, based on a type of the context information affected by the service action and a type of effect of the service action regardless of names and types of the actions of the application.

7. A system for detecting and resolving conflicts between context-aware applications, the system comprising:
a context consumer which receives a service request from an application;
an action semantic manager which analyzes a semantic of the requested service, registers the requested service, and removes the semantic to and from a data structure; and
a service interaction broker which determines whether a conflict occurs between service actions which are registered in the data structure, if the conflict occurs, requests the action semantic manager to remove the semantics of conflicting service actions from the data structure, generates a resolution policy for the conflict, and requests a new service according to the resolution policy.

8. The system of claim 7, wherein the data structure is an ontology which represents a type of effects actions of the application have on the context information, and affected context information.

9. The system of claim 7, wherein if the conflict does not occur, the service interaction broker executes the requested service.

10. The system of claim 7, wherein the service interaction broker determines whether the conflict occurs based on whether valid actions of the application according to a user policy have contradictory semantics in the data structure with respect to same context information.

11. The system of claim 7, wherein the service interaction broker determines conflicts between actions which are not predefined in advance in the data structure, based on a type of the context information affected by the service action and a type of effect of the service action regardless of names and types of the actions of the application.
